(19) United States
(12) Patent Application Publication
(10) Pub. No.: US 2006/0090028 A1
(43) Pub. Date: Apr. 27, 2006

(54) Passive differential voltage-to-charge sample-and-hold device

(76) Inventors: Michael P. Anthony, Andover, MA (US); Edward Kohler, Waltham, MA (US); Daniel Santiago, Waltham, MA (US)

Correspondence Address: DALY, CROWLEY, MOFFORD & DURKEE, LLP, SUITE 301A, 354A TURNPIKE STREET, CANTON, MA, 02021-2714, US

(21) Appl. No.: 10/952,454

(22) Filed: Sep. 27, 2004

(51) Int. Cl. G06F 12/14

(52) U.S. Cl. 711/100

(57) ABSTRACT

A sample-and-hold device provides output charge pairs which represent samples of a continuous-time differential input voltage. The device uses charge-coupled device elements in a symmetrical structure for splitting a constant input charge into a signal-dependent output charge pair. It is capable of operation at higher speed and with higher dynamic range than similar prior-art devices.

### CROSS REFERENCE TO RELATED APPLICATIONS

This invention was made with government support under Contract No. F19628-00-C-0002 awarded by the Air Force. The government has certain rights in the invention.

### STATEMENT REGARDING FEDERALLY SPONSORED RESEARCH

Not Applicable.

### BACKGROUND OF THE INVENTION

As is known in the art, many analog-to-digital conversion or discrete-time analog signal processing techniques require a sample-and-hold (sometimes called “track-and-hold”) circuit at or near their input. Such sample-and-hold (S/H) circuits develop a discrete analog output signal which is proportional to the value of the circuit's continuous-time input signal during a small window of time sometimes referred to as the aperture time. Many circuit and device designs have been used to provide the S/H function. Known implementations have used closed-loop (usually op-amp-based); active open-loop (emitter-follower-based etc.); and passive methods, including diode-bridge and metal-oxide semiconductor (MOS) switch circuits.

As is also known, discrete-time analog circuits and analog-to-digital converters can be implemented with charge-coupled devices (CCDs) in which signal samples are represented as charge packets. The S/H circuit for a (CCD) circuit converts an input signal (typically a voltage signal) to a proportional charge packet. Most known CCD signal-processing circuits use passive S/H devices.

To obtain relatively high CCD operating speeds it is necessary to utilize storage gates having relatively small storage-gate lengths. As used herein, length is the gate dimension parallel to the direction of charge transfer and ‘width’ refers to the orthogonal dimension. In any integrated circuit (IC) process, the fastest charge-domain device that can be built is a straight CCD shift register with gate lengths as short as permitted by the layout rules of the IC process. Any gates longer than this minimum reduce device operating speed below the maximum potential of the process.

High resolution (i.e., relatively Signal-to-Noise Ratio (SNR)) in a CCD signal-processing system requires large signal charges. The required charge is proportional to the square of the SNR. Large signal charge, in turn, requires large CCD storage-gate area. This requirement is at odds with the need to provide gates having relatively short gate lengths in order to obtain high speed. The practical consequence is that CCDs designed for both high speed and high resolution require gates which are much wider than they are long. Gates having width/length ratios of twenty or greater are typical.

### SUMMARY OF THE INVENTION

With the foregoing background in mind, it is an object of the present invention to provide a sample-and-hold (S/H) device having output charge pairs which represent samples of a continuous-time differential input voltage. The S/H device uses charge-coupled device elements in a symmetrical structure for splitting a constant input charge into a signal-dependent output charge pair. The resulting device is capable of operation at higher speed and with higher dynamic-range when compared with operating speeds and dynamic-ranges of prior-art S/H devices.

In accordance with the present invention, an S/H device includes a single electrode which corresponds to a merged charge-input barrier and splitting gate and which controls a single contiguous well. In one embodiment, the well is provided having a “Y”-shape. The S/H device further includes an input storage gate having a “V”-shape region which supplies charge to the merged input-barrier/splitting gate configuration. With this particular arrangement, an S/H device having a geometry which results in relatively high speed operation while having a relatively high signal-to-noise ratio (SNR) is provided. It should be appreciated that other gates in the S/H device are provided having geometric shapes selected to maintain the necessary contiguity for charge transfer.

In accordance with a further aspect of the present invention, a doubly differential sample-and-hold (S/H) device includes a first differential S/H device having a charge input path and first and second storage gates, a second differential S/H device having a charge input path and first and second storage gates, means for providing a first voltage to the first storage gate of the first differential S/H device and to the second storage gate of the second differential S/H device and means for providing a second voltage to the second storage gate of the first differential S/H device and to the first storage gate of the second differential S/H device. With this particular arrangement, a doubly differential sample-and-hold (S/H) device having a geometry which allows the circuit to provide the charges of the differential pair at any desired spacing, rather than contiguously. In one embodiment, charge input paths of each of the first and second differential S/H devices are adapted to receive a charge from a cascode charge-generator. The use of a cascode charge generator in combination with the charge-splitting S/H core is a new concept. Its advantage of improving SNR applies primarily to the doubly-differential S/H design.

The doubly-differential S/H design is a new concept circuit, providing spatially-separated outputs and improved SNR relative to the prior-art conventional S/H devices.

An in-line sample-and-hold (S/H) device includes fill-and-spill charge generator provided from a diffusion, and a first plurality of gates and a charge splitting device provided from a second plurality of gates. With this particular arrangement, an in-line S/H device in which the input charge is injected from one side of a charge-splitting device is provided. In one embodiment, the charge-splitting device is provided as a charge splitting gate triplet. This in-line S/H device delivers a single output charge at the highest sample rate possible with a given IC process geometry.

In accordance with a further aspect of the present invention, the use of multiple S/H unit cores with merged outputs to implement the two blocks of a doubly-differential S/H provides increased SNR without compromising speed. This concept depends on the doubly-differential structure, and could not be used with any of the differential-output designs enumerated in the prior art.

A multiple unit sample-and-hold (S/H) device includes a first plurality of S/H unit cores, each of said plurality of S/H unit cores having first and second voltage input terminals with first ones of the first and second voltage input terminals adapted to receive a first voltage and second ones of the first and second voltage input terminals adapted to receive a second voltage. With this particular arrangement, a doubly-differential S/H circuit having a reduced noise characteristic is provided. To take full advantage of the noise reduction available from the doubly-differential S/H circuit, the noise contribution of the input charge should be negligible relative to that of the S/H device itself. An improved SNR can be obtained by combining the doubly-differential S/H with a cascode charge generator used as the input-charge source. The overall SNR resulting from this combination may be relatively close to the ideal improvement of 3 dB. The doubly-differential S/H circuit, provides spatially-separated outputs and improved SNR relative to conventional S/H devices. The use of multiple S/H unit cores with merged outputs to implement the two blocks of the doubly-differential S/H, provide increased SNR without compromising speed.

### BRIEF DESCRIPTION OF THE DRAWINGS

The invention will be better understood by reference to the following more detailed description and accompanying drawings in which:

FIG. 1 is a schematic diagram of a voltage-to-charge sample-and-hold (S/H) device;

FIG. 2 is a cross-sectional view (in schematic form) of the S/H device of FIG. 1 taken along lines 2-2 in FIG. 1;

FIG. 2A is a diagram of channel potential in the portion of the S/H device shown in FIG. 2;

FIG. 2B is a cross-sectional view (in schematic form) of the S/H device of FIG. 1 taken along lines 2-2 in FIG. 1;

FIG. 2C is a diagram of channel potential in the portion of the S/H device shown in of FIG. 2B;

FIG. 3 is a cross-sectional view (in schematic form) of the S/H device of FIG. 1 taken along lines 3-3 in FIG. 1;

FIG. 3A is a diagram of channel potential in the portion of the S/H device of FIG. 3;

FIG. 3B is a cross-sectional view (in schematic form) of the S/H device of FIG. 1 taken along lines 3-3 in FIG. 1;

FIG. 3C is a diagram of channel potential in the portion of the S/H device shown in FIG. 3B;

FIG. 4A is a diagrammatic view of a prior art S/H device;

FIG. 4B is a schematic diagram of another prior art device;

FIG. 4C is a diagram of still another prior art device;

FIG. 4D is a schematic diagram of still another prior art device;

FIG. 5 is a diagrammatic view of an S/H having a merged barrier and splitting gate;

FIG. 6 is a cross-sectional view (in schematic form) of the S/H device of FIG. 5 taken along lines 6-6 in FIG. 5;

FIG. 6A is a diagram illustrating channel potential in the portion of the S/H device shown in FIG. 6;

FIG. 6B is a cross-sectional view (in schematic form) of the S/H device of FIG. 5 taken along lines 6-6 in FIG. 5;

FIG. 6C is a diagram illustrating channel potential in the portion of the S/H device of FIG. 6B;

FIG. 7 is a diagrammatic view of a doubly-differential sample-and-hold device;

FIG. 8 is a diagrammatic view of an in-line sample-and-hold-device;

FIG. 9 is a diagrammatic view of a doubly-differential in-line sample-and-hold device;

FIG. 10A is a diagrammatic view of an S/H unit core comprised of a charge source coupled to a S/H device;

FIG. 10B is a block diagram of an S/H unit core comprised of a charge source and an S/H device; and

FIG. 11 is a bock diagram of a doubly-differential S/H circuit including a plurality of S/H unit cores.

### DETAILED DESCRIPTION

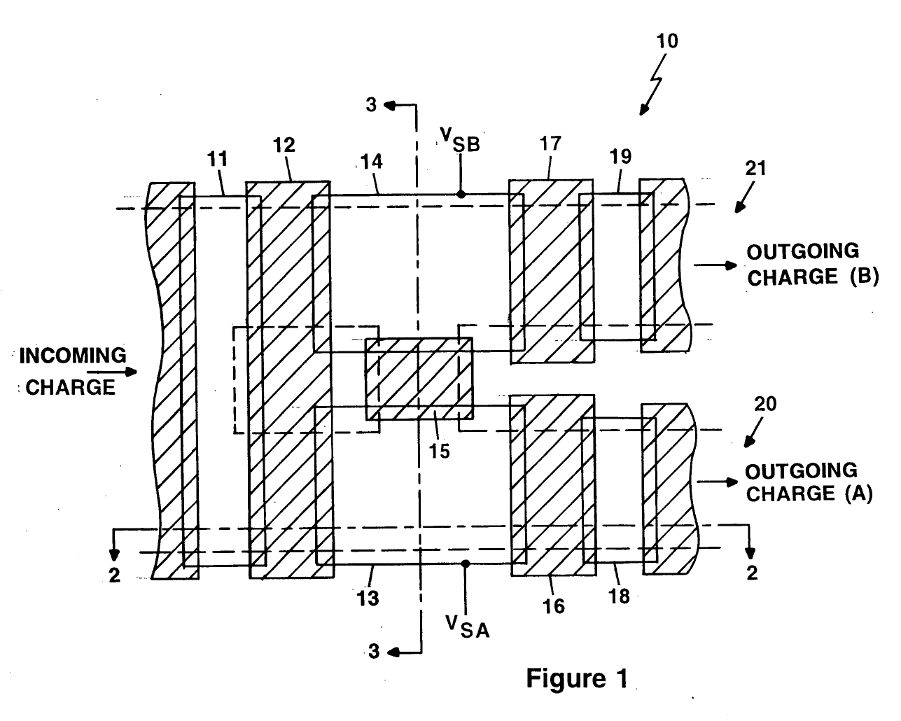

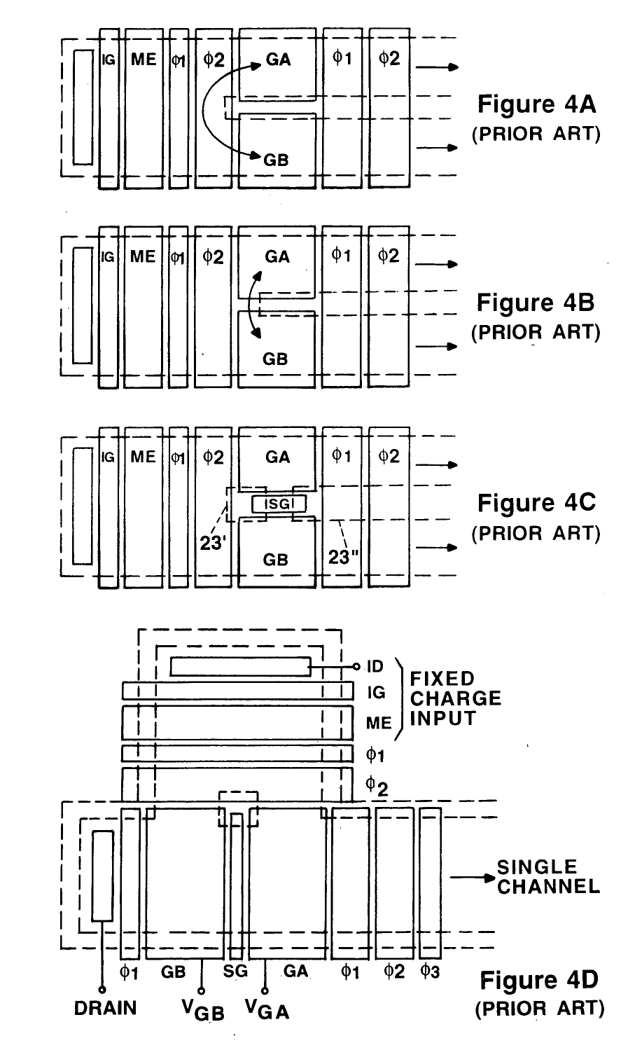

The present invention is directed toward a sample-and-hold (S/H) device that accepts a continuous-time differential voltage input signal, and develops a differential charge output signal at a sampling instant. This differential charge output comprises a pair of charge packets in a pair of output charge-coupled device (CCD) wells; the difference between the charges of this pair is proportional to the (differential) input signal, and their sum is essentially constant. The basic principle of operation of this differential voltage-to-charge S/H device is explained with reference to FIGS. 1, 2A, 2B, 3A and 3B. This basic principle is also embodied in the prior-art devices shown in FIG. 4A-4D.

In the following description the use of “4-phase” CCD technology, with two general types of gates, is assumed. These two types of gates are: (1) “storage gates”, under which charge packets reside during appreciable periods of time; and (2) “barrier gates” under which charges pass dynamically but are not generally stored. In one embodiment of the S/H device described below, one of the barrier gates serves a specialized dual function, as will be explained below.

Storage and barrier gates may be constructed in two separate layers of gate material, and can overlap; this type of construction is illustrated in FIGS. 1-3B and 5-9. Alternatively, storage and barrier gates may be constructed in a single layer of gate material without overlap. The basic S/H device principles discussed herein can also be embodied using other CCD technologies, such as the technologies included in the prior-art devices shown in FIGS. 4A-4D which employ 3-phase technology.

Referring now to FIG. 1, an S/H device 10 includes barrier gates 12, 15, 16 and 17 and storage gates 11, 13, 14 18 and 19. In operation, charge is supplied to the storage gate 11 from a source (not shown) such as a fill-and-spill structure, as indicated by the “incoming charge” arrow. Storage gate 11 and barrier gate 12 constitute a means of injecting a fixed charge packet under storage gates 13 and 14. Thus, at an appropriate time, the charge under gate 11 is injected via barrier gate 12 under storage gates 13 and 14.

Barrier gate 15 serves a “bridging” function, providing a conductive channel between gates 13 and 14 when in an “on” state. At an appropriate time, this gate is driven to an “off” state, thus isolating the charge packets then existing under gates 13 and 14. Barrier gate 16 and storage gate 18 and similar barrier and storage gates 17 and 19, respectively, constitute the first stages of a differential CCD output shift register with parallel channels 20, 21 Output channels 20, 21 convey charge packets isolated under gates 13 and 14 respectively as outgoing charges A and B This outgoing charge route is indicated by arrows for the paired channels 20,21.

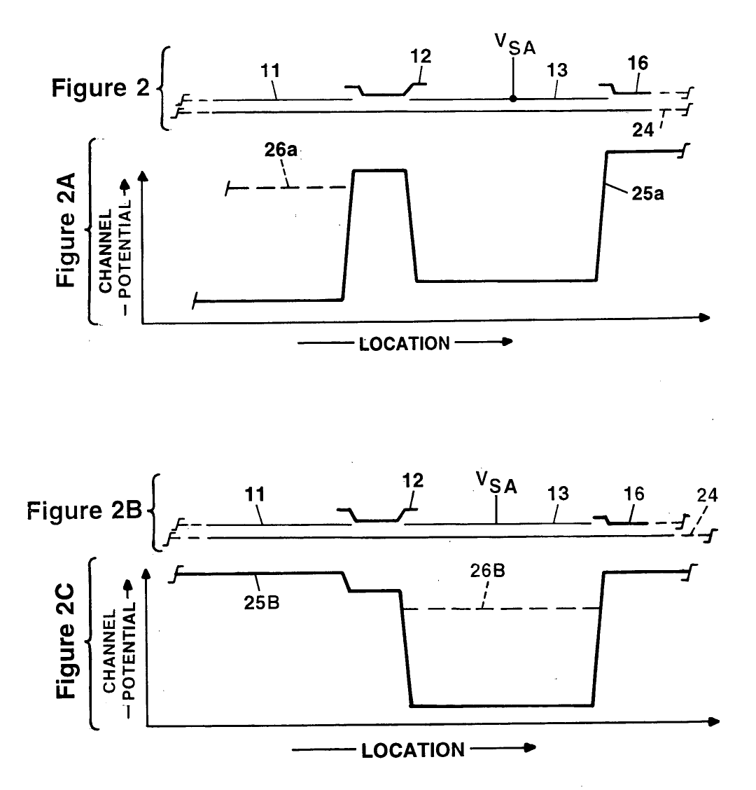

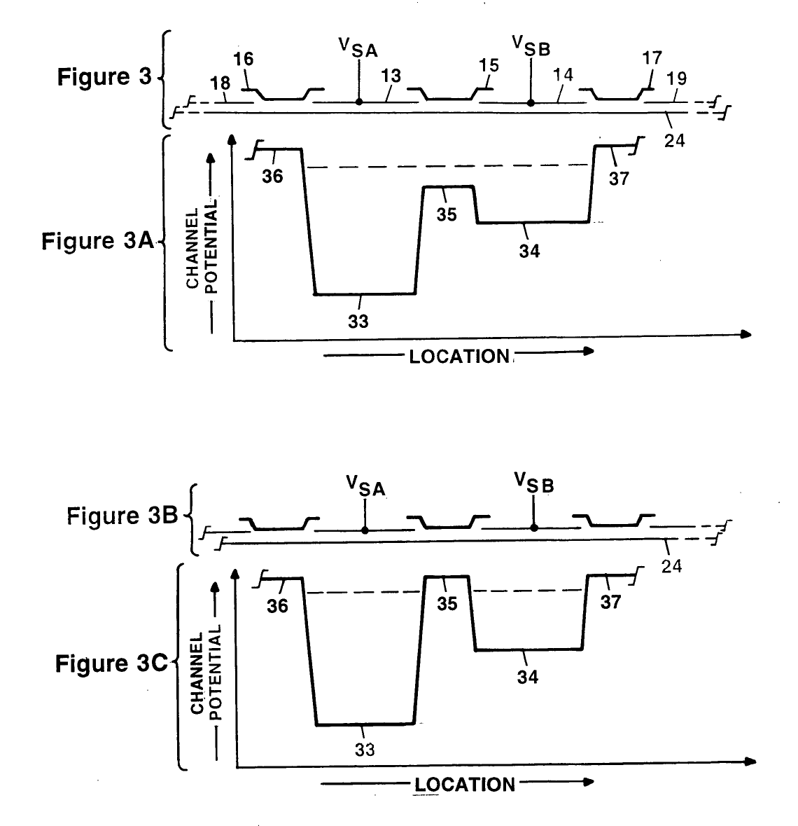

FIGS. 2, 2B, 3 and 3B correspond to cross-sectional views of the S/H device of FIG. 1 taken along lines 2-2 (for FIGS. 2 and 2B) and 3-3 (for FIGS. 3 and 3B). In these figures, like elements of FIG. 1 are provided having like reference designations. In FIGS. 2 and 2B, these elements include storage gates 11 and 13 and barrier gates 12 and 16. In FIGS. 3 and 3B, these elements include storage gates 13, 14, 18 and 19 and barrier gates 15, 16 and 17. In addition, in FIGS. 2, 2B, 3, and 3B a line 24 represents schematically a semiconductor surface under an oxide layer. Also in FIGS. 2-3C, overlaps of storage gates by barrier gates are indicated; as mentioned above, such overlaps are typical of one class of CCD processes, and serve in these figures to visually distinguish the two gate types.

FIGS. 2A, 2C, 3A and 3C correspond to so-called “bucket diagrams” which illustrate the channel potentials under the CCD gates of the S/H device 10 and illustrate the effects of charge under the gates. To aid in understanding the description of FIGS. 2-3C, the schematic cross-sectional view of FIGS. 2 and 2B have been aligned over the respective bucket diagrams of FIGS. 2A and 2C, and similarly the schematic cross-sectional view of FIGS. 3 and 3B have been aligned over the respective bucket diagrams of FIGS. 3A and 3C. The channel potentials depicted in FIG. 2A correspond to the aligned gates depicted in FIG. 2; likewise the potentials in FIG. 2C correspond to the aligned gates in FIG. 2B, the potentials in FIG. 3A to the aligned gates in FIG. 3, and the potentials in FIG. 3C to the aligned gates in FIG. 3B.

FIGS. 2A and 2C each illustrate channel potential at different locations in the structures of FIGS. 2 and 2B under different conditions. The solid lines 25a, 25b (FIGS. 2A and 2C, respectively) represent channel potential with mobile charge absent; the dashed lines 26a, 26b in FIGS. 2A and 2C respectively, illustrate the potential with charge present. The dashed and solid channel-potential lines in FIGS. 3A and 3C have equivalent meanings. Upward on the diagrams indicates a more positive (less attractive) potential for mobile charges. (For electrons, this direction corresponds to a relatively negative gate voltage.) FIGS. 2A, 2C, 3A and 3C illustrate the sequence of operations mentioned briefly in the discussion of FIG. 1.

FIG. 2A illustrates channel potentials taken along section 2-2 of FIG. 1 at the start of the process for accepting a continuous time differential voltage input signal and developing a differential charge output signal at a sampling instant. Initially, both storage gates 11 and 13 are “turned on”—i.e., made attractive to mobile charge. A packet of charge has been supplied to gate 11, producing the dashed-line channel potential 26a shown. Any charges previously present under gate 13 have been removed. It should be noted that gate 15 (FIG. 3) and storage gate 14 (FIG. 3) are also turned on and devoid of charge at this time. A section parallel to line 2-2′ in FIG. 1 through gate 14 would have channel potentials similar to the one shown in FIG. 2A.

Referring now to FIG. 2C, the channel potentials of the same elements discussed in conjunction with FIG. 2A are shown after the charge that was under gate 11 is injected under gates 13, 14, and 15. Gate 12 was turned on during this charge injection, then turned off again after it is complete. Because gate 12 is turned off in FIG. 3C, the charge is isolated under gates 13, 14 and 15, and cannot flow backwards during subsequent steps. At this time gates 16 (shown) and 17 (not shown) are also turned off, preventing forward charge movement as well.

FIG. 3C shows the potentials and charges along section 3-3 (FIG. 1) after the charge from gate 11 is injected (the same time as FIG. 2C). The empty-well potentials 33 and 34 depend upon the input signal voltages V_{SA} and V_{SB} applied to signal-input gates 13 and 14 respectively. Because gate 15 is turned on, charge flows between gates 13 and 14 to maintain the channel potentials at the same equilibrium level, as shown. The total charge under gates 13, 14, and 15 is constant; it redistributes itself in response to input voltages V_{SA} and V_{SB} such that the charge difference is proportional to the voltage difference.

At the moment of sampling, barrier gate 15 is turned off, causing the charges under gates 13 and 14 to be isolated. This situation is shown in FIG. 3C. The charge that was under gate 15 before it was turned off is split between gates 13 and 14. At this point, the sampling operation is complete: two isolated packets of charge are located under gates 13 and 14; their difference is proportional to the input voltage difference at the sampling instant when gate 15 was turned off.

The now-isolated charge packets under gates 13 and 14 are shifted out by gates 16 and 18 and by gates 17 and 19 as usual in CCD shift registers. A new charge packet is delivered to gates 13-15 from gate 11, and the process repeats for the next sample.

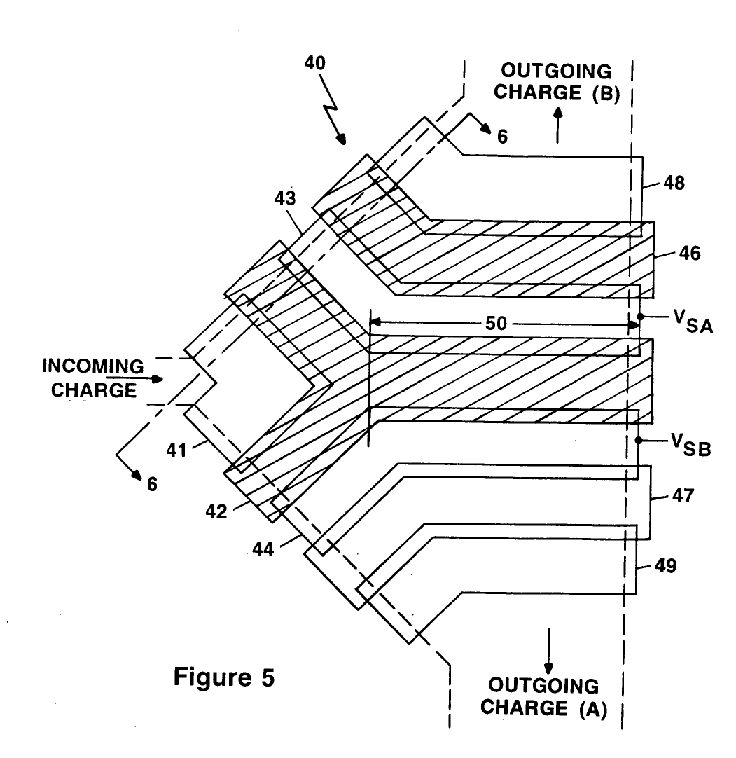

The basic S/H principle explained above is used both in the present invention, as described below in conjunction with the discussion of FIGS. 5-11, and in the prior-art devices shown in FIGS. 4A-4D.

The prior-art devices have several deficiencies in geometrical layout which make their application in high-speed, high-resolution differential CCDs impractical. The following discussion of these deficiencies refers to the layouts shown in FIGS. 4A-4D. Note that although these prior-art devices as illustrated are implemented using three-phase CCD technology, the same layouts can be implemented using four-phase CCD technology as well. The limitations of these prior-art devices apply regardless of this implementation choice. Note also that in these devices, the gates identified as “GA” and “GB” correspond to the gates V_{SA} and V_{SB} in FIG. 1; in both cases, these are the gates which receive the input voltage to be sampled.

The unsuitability of the prior-art S/H designs for high-speed, high-resolution applications arises from the fact that three different charge flows must occur under the signal-input gates GA and GB. The first charge flow is the initial injection of input charge under GA and GB. The second charge flow is the equilibration of charge between the signal-input gates. The third charge flow is the transfer of isolated charge from the signal-input gates into the continuing CCD channels.

In none of the layouts shown in FIGS. 4A-4D can all three of the above described charge flows be in the same direction. Since at most only one of the gate dimensions can be at the process minimum, at least one of the three charge flows discussed above must be slower than the maximum speed of which the process is capable, thereby preventing the device from operating at the maximum speed potential of the process. The manifestation of this limitation in each of the prior-art layouts is described below.

The layout of FIG. 4A avoids the necessity of lengthening GA and GB by providing a path for charge equilibration between GA and GB though the preceding gate, labeled Φ₂. This path, however, is relatively long and narrow, thus limiting the input signal bandwidth as described above. With this layout, high-SNR applications, where the widths of GA and GB must be large, exacerbate this problem.

Referring now to the device layout shown in FIG. 4C, it is a design requirement that the lengths of gates GA and GB be sufficient to accommodate both the width of gate SG and of the isolation (non-active-area) islands, 23′ and 23″. This length constraint dictates that the length of gates GA and GB be longer than the minimum for a CCD shift register. The result is a degradation of CCD charge-transfer speed below the maximum allowed by the process, with a consequent reduction in the device sample rate.

When the lengths of GA and GB in FIG. 4C are made as small as possible within the constraint just described, another defect of the layout in FIG. 4C arises: the width of gate SG must be minimized. The result is that the conductance of the region under gate SG is small. This means that the speed of the charge-equilibration process between gates GA and GB in response to the input voltage signal is limited, reducing the input signal bandwidth of the S/H device. For high-SNR applications where the capacitance of GA and GB must be large, this problem is severe.

Referring now to the device layout of FIG. 4B, no separate gate (like SG in FIG. 4C) is provided to control charge equilibration between GA and GB. Rather, GA and GB are coupled by a shared channel region, identified by the arrow indicating charge flow. This region, like gate SG in FIG. 4C, requires gates GA and GB to be greater than minimum length. If Gates GA and GB are wide, in order to support high-SNR application, then the limited conductance of this coupling region results in low signal bandwidth, as with layout 4C. Moreover, the layout of FIG. 4B does not provide a gate for isolating the sampled charge packets under GA and GB, and thus reduces S/H performance of this layout.

In the layout of FIG. 4D the charge-equilibration process is as fast as possible, since the width of gate SG is (nearly) as great as that of GA and GB. However, the length of GA and GB must be great enough to accommodate initial charge injection. This constraint is similar to the one described above, and results in a reduction of output charge-transfer speed. In addition, reducing the length of GA and GB as much as possible constrains the width of the initial charge-injection path, thus slowing that phase of device operation. Finally, with this geometry, the initial charge must flow along the width of the signal-input gates GA and GB; with very wide gates, as needed for high signal-to-noise ratio (SNR), this charge flow becomes the speed-limiting process. Finally, the layout of FIG. 4D provides only single-ended charge output, which is unsuitable for many CCD applications.

Thus it is seen that none of the device layouts of the prior art are capable of realizing overall device speed consistent with the basic CCDs available in a given process. Moreover, as gate area is increased in order to support higher SNRs, these speed-limiting problems become more severe.

A second limitation of prior-art S/H devices is the output SNR. The output charge noise is proportional to (kTC)^{1/2}, where C is the capacitance of the signal-input gates GA and GB k is Boltzman's constant and T is temperature. In the differential-charge-output configurations of FIGS. 4A-4C, the charge noise in the two output channels is fully correlated, so the differential-charge noise is twice that of either individual channel. The output differential-charge noise is, however, largely immune to noise in the input charge packet before splitting. The single-ended-output S/H configuration shown in FIG. 4D has a SNR roughly equal to that of the differential configurations (for comparable total gate areas), because it is not immune to noise from the charge-packet generator (gates IG, ME, etc.).

A third limitation of prior-art S/H devices in the differential-output configurations (FIGS. 4A-4C) is that the output CCD registers are immediately adjacent. In many applications these registers need to be separated, allowing space between them for other circuitry. In order to accommodate this requirement, the prior-art S/H device must be followed by an angled (“V”-shaped) section of CCD registers in which the two channels diverge to the needed spacing. This requirement adds additional CCD stages otherwise unnecessary, causing signal degradation and consuming additional chip area and power.

Referring now to FIG. 5, an S/H device 40 having an S/H geometry which alleviates the problems described above for high-speed applications is shown. The device shown in FIG. 5 and the description below presume implementation in a 4-phase technology with two-layer gates, as described above.

Turning now to FIG. 5, an S/H device 40 includes an input charge storage gate 41 having a V-shape, in which incoming charge is received. Disposed over selected portions of the input charge storage gate 41 is a merged charge-input barrier/splitting gate 42 having a Y-shape. Thus, the S/H device 40 includes a merging of a charge-input barrier gate (e.g. gate 12 in FIG. 1) with a splitting gate (e.g. gate 15 in FIG. 1) into a single electrode 42 controlling a single contiguous well laid out in a Y-shaped pattern. The input storage gate 41 (equivalent to gate 11 in FIG. 1) is made “V”-shaped to accommodate the configuration of the input-barrier gate 42; and the other gates shown in FIG. 5 are geometrically adjusted to maintain the necessary contiguity for charge transfer. The functions of all gates in FIG. 5 except for gate 42 are equivalent to corresponding gates described above in conjunction with FIG. 1. For example, in FIG. 5 gate 43 is equivalent to gate 13 in FIG. 1, gate 44 is equivalent to gate 14, etc.

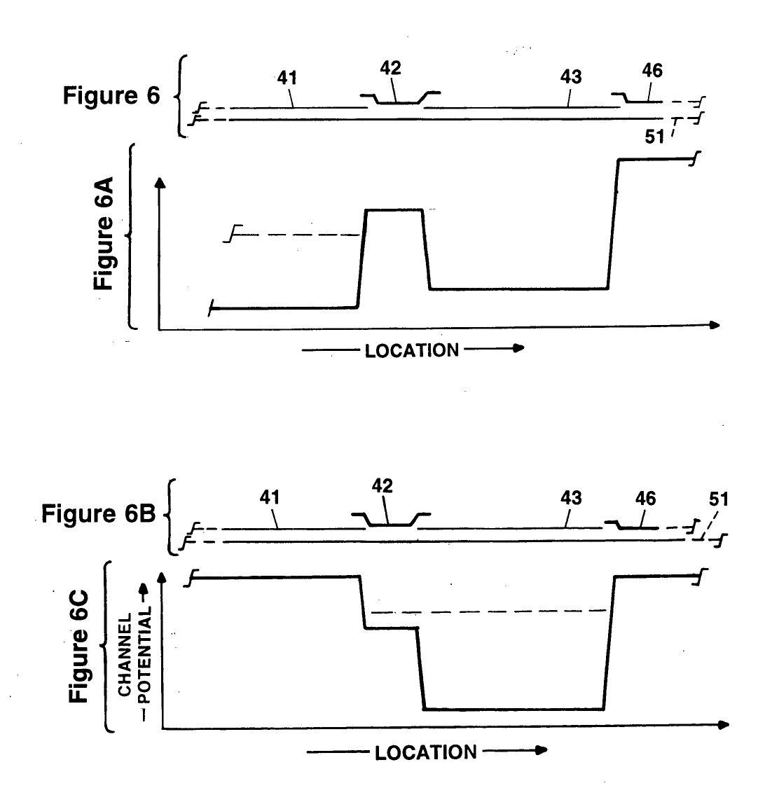

FIGS. 6 and 6B are cross-sectional views of the S/H device 40 shown in FIG. 5 with the cross-sections being taken along line 6-6 in FIG. 5. In these figures, like elements of FIG. 5 are provided having like reference designations. These elements include storage gates 41 and 43, barrier gate 46 and combined charge-input-and-splitting gate 42. In addition, in these figures a line 51 represents schematically a semiconductor surface under an oxide layer beneath gates 41, 42, 43 and 46.

FIGS. 6A and 6C correspond to so-called “bucket diagrams” which illustrate channel potentials under the CCD gates of the S/H device 40 and which illustrate the effects of charge under the gates. To aid in understanding the operation of the S/H device 40 and the description of FIGS. 6-6C, the cross-sectional view of FIGS. 6 and 6B have been aligned over the respective bucket diagrams of FIGS. 6A and 6C. The channel potentials depicted in FIGS. 6A and 6C correspond to the aligned gates depicted in FIGS. 6 and 6B respectively.

Operation of the S/H device of FIG. 5, as shown in FIGS. 6-6C, differs from the operation of the S/H device of FIG. 1, described above in conjunction with in FIGS. 2-2C and 3-3C as follows: since the same gate, 42 in FIGS. 6 and 6B, serves the function of input-barrier gate 12 in FIGS. 2 and 2B as well as splitting gate 15 in FIGS. 3 and 3B, it is impossible to have a separate potential as for gate 12 in FIGS. 2-2C. Consequently gate 42 in FIG. 6-6C is held at the same potential as gate 15 in FIGS. 3-3A. The revised potential sequence is shown in FIGS. 6A and 6C, corresponding to the same times as in FIGS. 2A and 2C. The result of this modified operation is that, after input charge is transferred from gate 41 to gate 43, some of the input charge also resides under gate 42, as shown in FIG. 6C. In all other regards, operation is identical to that shown in FIGS. 2-2C.

Operation of the S/H device of FIG. 5 during the sampling and charge-splitting portions of its operating cycle is identical to the operation of the device of FIG. 1, as depicted in FIGS. 3-3C. FIGS. 3-3C apply exactly to a section of the device of FIG. 5 taken along line 6x-6x.

By providing a merged barrier/splitting gate having a Y-shape, CCD charge transfers into, within, and out of the splitting structure (gates 42, 43, 44) all involve traversing minimum or near-minimum gate lengths, thereby assuring operation at a speed near the process maximum. The merged barrier/splitting gate also allows the S/H device to have a bridge-gate width nearly the whole width of the input gates (the straight-line portion of gate 42, identified as 50 in FIG. 5), thus providing input signal bandwidth near the maximum attainable in the process. Thus the Y-shape of the combined input-charge barrier and charge-splitting gate 42 provides a relatively high-speed S/H device compared to the prior-art designs.

The parallel CCD registers in many differential CCD signal-processing circuits need to be separated, allowing space between them for other circuitry. This requirement can be met by a doubly-differential S/H which combines two differential S/H devices such as those shown in FIG. 5, with their inputs driven in opposite phase, and with one output from each device discarded.

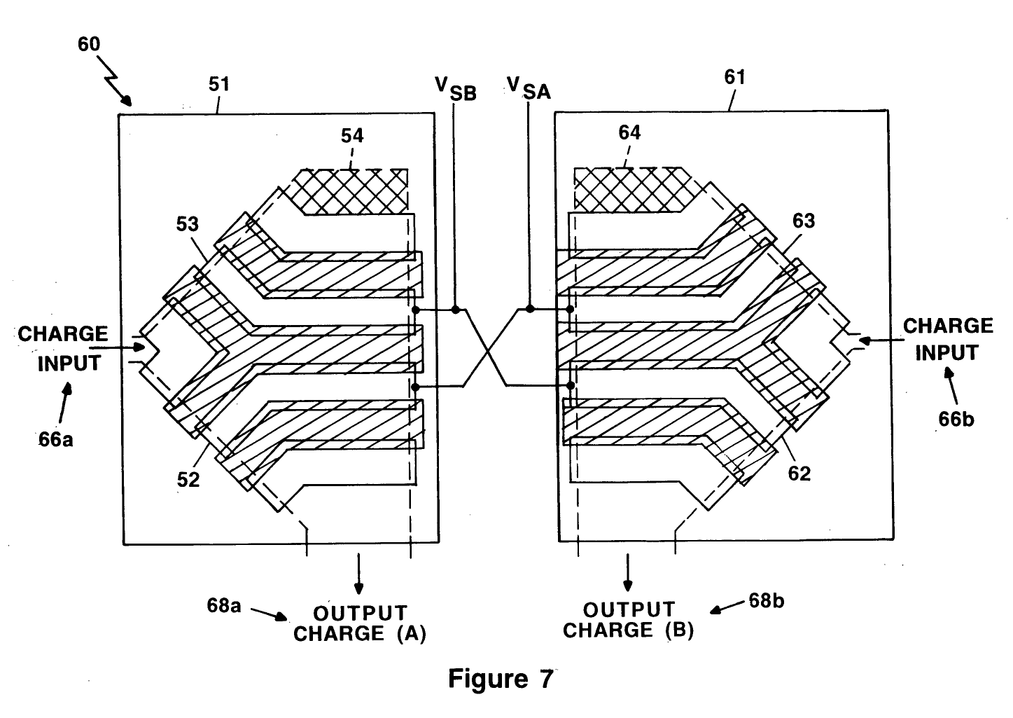

Referring now to FIG. 7, a complete doubly-differential S/H circuit 60 includes a first differential S/H device 51 and a second differential S/H device 61. In the exemplary embodiments of FIG. 7, the S/H devices are provided as the types described above in conjunction with FIG. 5. It should be appreciated of course that in other embodiments, the S/H devices 51, 61 which make up the doubly-differential S/H circuit 60 may be provided as the types described above in conjunction with FIGS. 1 and 4A-4D. In the case where the S/H devices 51, 61 are provided from devices as shown in FIG. 4D, the voltage V_{sb} in FIG. 7 is coupled to V_{gb} (FIG. 4D) on one S/H device and V_{ga} (FIG. 4D) on the other S/H device and vice-versa for the Vₛₐ voltage.

It should also be appreciated that in some embodiments device 51 may be provided having a geometry which is different than device 61 (that is, the circuit 60 may not be symmetric).

The differential signal-input gates 52, 53 and 62, 63 are driven by the same differential voltages V_{SA}, V_{SB}, but with the phase reversed between the two blocks. All other corresponding gates in the two blocks are driven by identical clocks, with timing as described above. The input-charge streams to 66a, 66b to devices 51 and 61 are nominally the same. One output charge from each device 51, 61 is absorbed by a respective one of drains 54 and 64 respectively. The remaining output charges 68a, 68b from the two devices 51, 61 constitute the differential-charge output of the doubly-differential S/H 60.

With identical input charges and perfect symmetry, the output-charge pair is identical to what would be obtained from the single differential S/H device shown in FIG. 5. In particular, the even-harmonic-suppression property due to the symmetrical structure of FIG. 5 is retained. The geometrical advantage of the doubly-differential S/H circuit 60 is to provide the charges of the output differential pair at any desired spacing, rather than contiguously. Moreover, in a doubly-differential architecture, the fact that the charge outputs from the S/H of FIG. 5 flow in opposite directions is not a disadvantage.

A second benefit of the doubly-differential S/H circuit 60 is that the noise components in the two outputs are not correlated as they are in differential designs of the prior art. This means that the SNR at the S/H circuit 60 output is ideally improved by 3 dB compared to the prior art, if input charge noise is negligible. (If input-charge noise is not negligible, then less improvement in output SNR of the S/H may be obtained.)

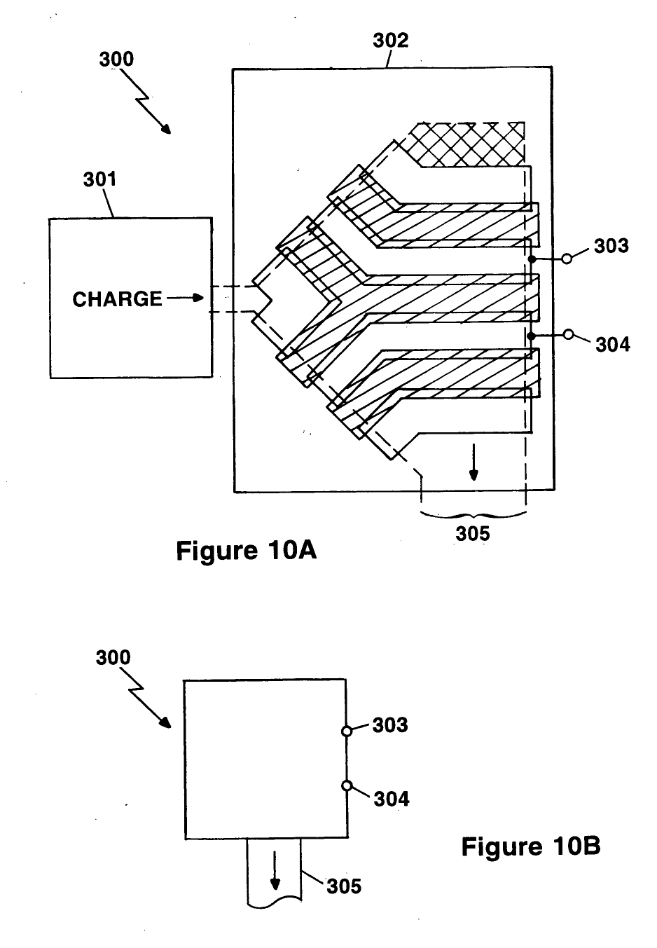

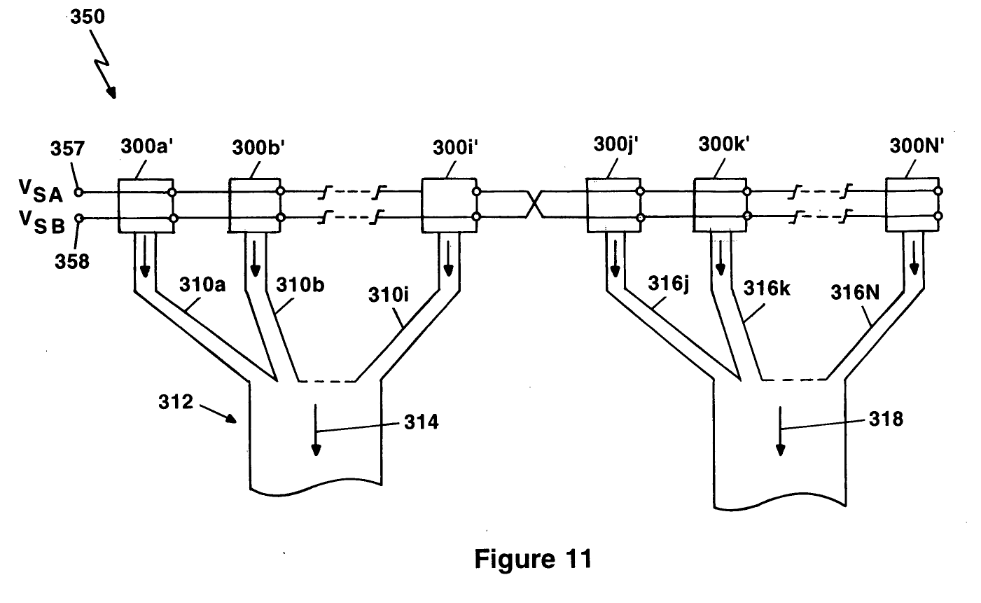

A third benefit of the doubly-differential S/H circuit 60 applies in the case of high-SNR applications. As discussed above, high SNR requires large gate width. (Recall that ‘width’ refers to the gate dimension perpendicular to the primary direction of charge flow. For example, in FIG. 5 the width of the device is the dimension perpendicular to the direction of outgoing charge flow.) With sufficiently wide gates, the propagation of the input charge supplied from gate 41 in FIG. 5 along the width of gates 42, 43, and 44 becomes a speed-limiting process. With the doubly-differential S/H circuit 60, the free placement of the output channels provides a solution to this limit: each S/H device which make up the doubly-differential S/H circuit 60 (e.g. devices 51, 61) can be composed of multiple copies of S/H devices (e.g. devices similar to those described in FIG. 5) with each S/H device having a small enough width to avoid the input-charge-propagation-speed issue. The output charge streams from these multiple S/H devices are then merged into a wider CCD channel. This concept is explained further below in conjunction with FIGS. 10A, 10B and 11.

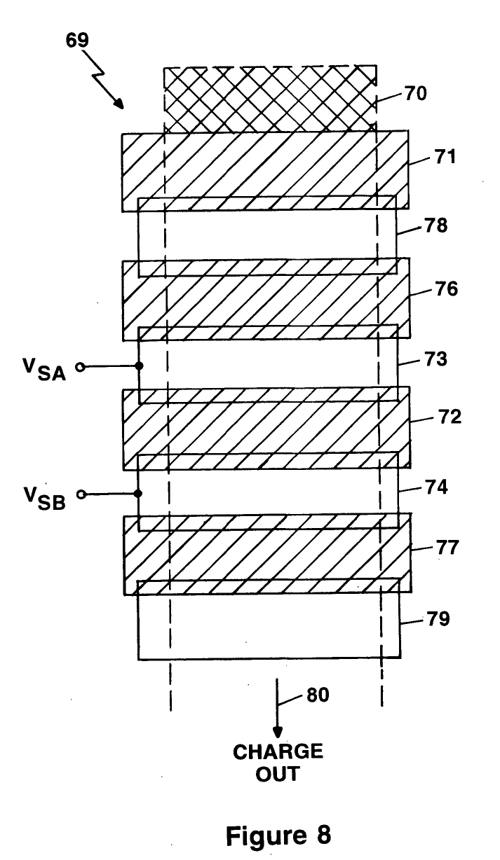

When maximum speed is the primary goal in designing an S/H device of the general type being discussed, and some SNR and linearity can be sacrificed, then another S/H geometry, the in-line S/H device, is possible. This design is shown in FIG. 8. The operation of this device is as follows.

An in-line S/H device 69 includes diffusion 70 and gates 71 and 78 which together constitute a fill-and-spill charge generator, with the resulting charge packet held under gate 78. This charge is injected via gate 76 under gates 73, 72, and 74, which constitute a charge-splitting triplet equivalent to gates 13, 15 and 14 in FIG. 1. Charge-splitting in this triplet proceeds as described above in connection with FIGS. 3-3C. The resulting charge packets are isolated under gates 73 and 74 when splitting gate 72 turns off. The charge packet under gate 74 is output via gate 77 as in the previous designs, providing a single-ended charge output 80. The packet under gate 73, however, is output via gate 76, whence it re-appears under gate 78. During the next fill phase of the fill-and-spill, this charge merges with the incoming charge from diffusion 70, and is discarded during the spill phase. The net effect is like one of the differential S/H devices shown in FIG. 7, in which one charge is discarded after splitting while the other is output.

In this design, all three charge movements necessary to S/H operation occur along the same axis, not (as in the prior art) in orthogonal directions. As a consequence, this in-line layout is the fastest possible implementation of this basic S/H concept in a given CCD process geometry. Because the charge input to the S/H device of this design is of the fill-and-spill type, its SNR is reduced compared to a design based on FIG. 5 with a cascode charge generator.

This in-line S/H device has a single-ended charge output, even though its input signal voltage is sensed differentially. In some applications this single-ended output may be suitable. If differential output charge is required, two S/H cores of this type can be combined, with inputs driven in opposite phase, to construct a doubly-differential S/H circuit like that in FIG. 7.

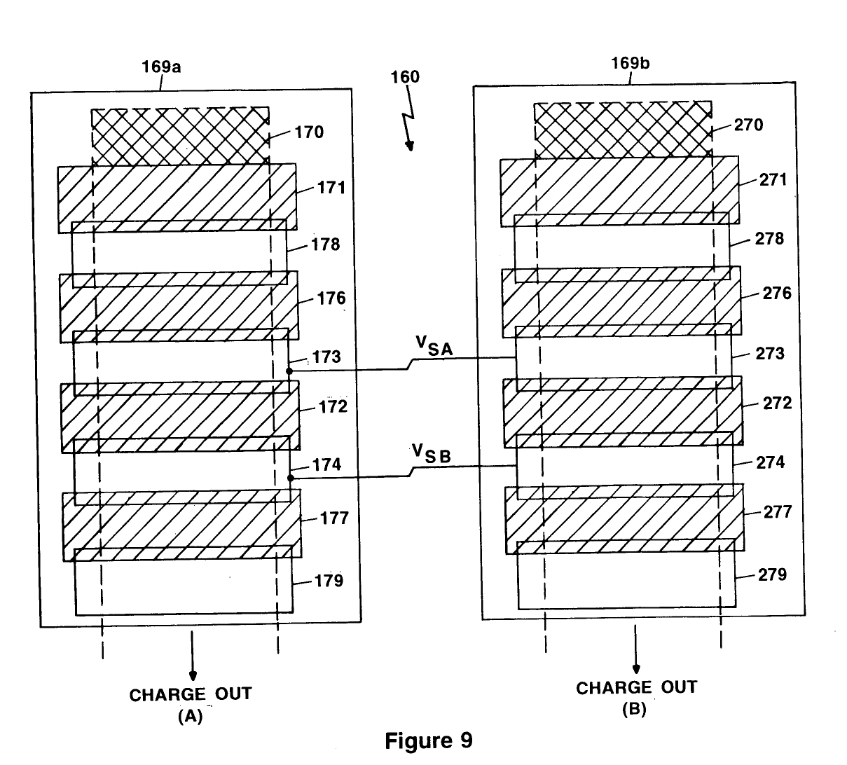

FIG. 9 shows a complete doubly-differential S/H circuit 160 in accordance with this new design. This design includes two S/H devices 169a, 169b which may be similar to the in-line S/H device 69 described in FIG. 8. This circuit 160 operates in a similar fashion as the doubly differential design of FIG. 7. Storage gates 173, 174 and 273, 274 are driven by the same differential voltages V_{SA}, V_{SB}, but with the phase reversed between the two devices 169a, 169b. All other corresponding gates in the devices are driven by identical clocks, with timing as described earlier. The input-charge streams to blocks 170 and 270 are nominally identical. The output charges from the two circuits making up the doubly-differential design constitute the differential-charge output of the S/H.

In view of the above, the disclosed in-line S/H circuit designs provide significant advantages over the prior art while retaining all of the previously discussed benefits. The disclosed designs permit S/H speed essentially as high as the maximum CCD speed supported by the process in which the designs are implemented. The prior art designs were substantially slower. The disclosed designs permit the use of large CCD gate area, needed for high SNR, without compromising the operating speed of the device. Prior-art designs required a reduction in input bandwidth or sample rate in order to obtain higher SNR. The doubly-differential implementation shown in FIG. 9 provides these benefits together with differential charge output and spatially-separated differential outputs not available with the prior art.

Referring now to FIG. 10A, an S/H unit core 300 includes a charge source 301 which provides charge to a charge input path of an S/H device 302. The S/H device 302 has first and second voltage input terminals 303, 304 coupled to gates thereof. The S/H device 302 may be similar to the S/H device 40 described above in conjunction with FIG. 5.

Various types of charge sources suitable for this application are known. A cascode charge source is preferred, because of its low noise. Other charge sources, may however, also be used.

An input differential voltage to be sampled is applied to terminals 303, 304, as in FIG. 5.

The S/H device 302 also includes a charge output path 305. This output path 305 would ordinarily couple to an ongoing CCD shift register.

Referring now to FIG. 10B, the S/H unit core 300 of FIG. 10A is shown as a block diagram with like elements of FIG. 10A having like reference designations in FIG. 10B.

Referring now to FIG. 11, complete doubly-differential S/H circuit 350, includes a plurality of S/H unit cores 300a′-300N′. Each of the S/H unit cores 300a′-300N′ may be similar to the S/H unit core 300 described above in conjunction with FIGS. 10A, 10B. All S/H unit cores 300a′-300i′ are connected in identical phase to the input voltages V_{SA} and V_{SB}, while S/H unit cores 300k′-300N′ are connected in opposite phase to the input voltages. It should be appreciated that while three units of each phase are illustrated, more or fewer units can be employed.

The charge outputs 310a-310i from units 300a′-300i′ are combined by merging in a CCD channel 312, resulting in a combined charge output 314. Similarly, charge outputs 316j-316N from units 300j′-300N′ are merged to produce combined charge output 318. The complete doubly-different S/H circuit 350 is functionally equivalent to the doubly-differential S/H circuit shown in FIG. 7 with differences including that the charge sources are explicitly included in the S/H unit cores, and that multiple S/H unit cores are employed on circuit 350.

In order to take full advantage of the noise reduction available from the doubly-differential S/H circuit 350, the noise contribution of the input charge should be negligible relative to that of the S/H device itself (e.g. the S/H device shown in FIG. 5). The input charge source can be of the type known as “fill-and-spill.” A fill-and-spill charge source has noise comparable to that of the S/H device. As a result, the doubly-differential S/H circuit with such a charge source would have approximately the same SNR as the singly-differential S/H circuit of FIG. 5.

An improved SNR can be obtained by combining the doubly-differential S/H described above with a cascode charge generator used as the input-charge source. That charge source can have substantially lower noise than the fill-and-spill type. As a result, the overall S/H resulting from this combination may provide nearly the full 3 dB SNR improvement theoretically possible.

The doubly-differential S/H circuit, provides spatially-separated outputs and improved SNR relative to conventional S/H devices. The use of multiple S/H unit cores with merged outputs to implement the two blocks of the doubly-differential S/H, provide increased SNR without compromising speed.

It should be appreciated that the use of a cascode charge generator in combination with the charge-splitting S/H core is a new concept. Its advantage of improving SNR applies primarily to the doubly-differential S/H design. Also, the in-line S/H design of FIG. 8, in which the input charge is injected from one side of the charge-splitting gate triplet, is a new concept, providing the fastest possible implementation of the basic charge-splitting S/H.

Having described preferred embodiments of the invention it will now become apparent to those of ordinary skill in the art that other embodiments incorporating these concepts may be used. Accordingly, it is submitted that that the invention should not be limited to the described embodiments but rather should be limited only by the spirit and scope of the appended claims.

What is claimed is:

1. A sample-and-hold (S/H) device comprising:
a first storage gate for receiving an input charge;
a merged barrier-and-splitting gate having a shape selected to provide a predetermined gate length, said merged barrier-and-splitting gate disposed such that charge can be coupled between said merged barrier-and-splitting gate and said first storage gate;
a second storage gate disposed such that charge can be coupled between said second storage gate and said merged barrier-and-splitting gate, said second storage gate receiving a portion of a charge from said merged barrier-and-splitting gate, said second storage gate controllable by a first voltage; and
a third storage gate disposed such that charge can be coupled between said third storage gate and said merged barrier-and-splitting gate, said third storage gate receiving a portion of the charge from said merged barrier-and-splitting gate, said third storage gate controllable by a second voltage, and wherein said first storage gate, said merged barrier-and-splitting gate, said second storage gate, and said third storage gate each having a shape selected to provide charge continuity between adjacent gates.

2. The device of claim 1 further comprising a second barrier gate disposed adjacent said second storage gate, said second barrier gate having a shape such that charge continuity is provided between said second barrier gate and said second storage gate.

3. The device of claim 2 further comprising a third barrier gate disposed adjacent said third storage gate, said third barrier gate having a shape such that charge continuity is provided between said third barrier gate and said third storage gate.

4. The device of claim 3 further comprising a fourth storage gate disposed adjacent said second barrier gate, said fourth storage gate having a shape such that charge continuity is provided between said fourth storage gate and said second barrier gate, said fourth storage gate providing a first output signal.

5. The device of claim 4 further comprising a fifth storage gate disposed adjacent said third barrier gate, said fifth storage gate having a shape such that charge continuity is provided between said fifth storage gate and said third barrier gate, said fifth storage gate providing a second output signal.

6. The device of claim 1 wherein said merged barrier-and-splitting gate is provided having a generally Y shape.

7. The device of claim 1 wherein said first storage gate is provided having a generally V shape.

8. A doubly differential sample-and-hold (S/H) device comprising:
a first differential S/H device having a charge input path and first and second storage gates;
a second differential S/H device having a charge input path and first and second storage gates;
means for providing a first voltage to the first storage gate of said first differential S/H device and to the second storage gate of said second differential S/H device; and
means for providing a second voltage to the second storage gate of said first differential S/H device and to the first storage gate of said second differential S/H device.

9. The device of claim 8 wherein at least one of said first and second S/H devices is provided having a merged barrier-and-splitting gate.

10. The device of claim 9 wherein said first S/H device is provided having a merged barrier-and-splitting gate and the first and second storage gates of said first S/H device are disposed adjacent said merged barrier-and-splitting gate.

11. The device of claim 9 wherein said second S/H device is provided having a merged barrier-and-splitting gate and the first and second storage gates of said first S/H device are disposed adjacent said merged barrier-and-splitting gate.

12. The device of claim 8 wherein at least one of said first and second S/H devices is provided having a barrier gate which is separate from a splitting gate.

13. The device of claim 12 wherein said first S/H device is provided having separate barrier and splitting gates and the first and second storage gates of said first S/H device are disposed adjacent the splitting gate.

14. The device of claim 12 wherein said second S/H device is provided having separate barrier and splitting gates and the first and second storage gates of said first S/H device are disposed adjacent the splitting gate.

15. The device of claim 8 further comprising means for draining a charge packet from said first storage gate in said first S/H device.

16. The device of claim 15 further comprising means for draining a charge packet from said first storage gate in said second S/H device.

17. The device of claim 16 further comprising one or more gates disposed adjacent said second gate of said first S/H device to define an output charge path on said first S/H device.

18. The device of claim 17 further comprising one or more gates disposed adjacent said second gate of said second S/H device to define an output charge path on said first S/H device.

19. The device of claim 8 wherein the charge input paths of each of said first and second differential S/H devices are adapted to receive a charge from a cascode charge-generator.

20. The device of claim 8 further comprising:
a first cascode charge-generator coupled to the charge input path of said first S/H device; and
a second cascode charge-generator coupled to the charge input path of said second S/H device.

21. An in-line sample-and-hold (S/H) device comprising:
a fill-and-spill charge generator provided from a diffusion, and a first plurality of gates, wherein a charge packet provided from said fill-and-spill charge generator is held under one of said first plurality of gates;
a charge splitter provided from a second plurality of gates;
a barrier gate which controls injection of the charge packet being held under one of said first plurality of gates under said second plurality of gates which provide said charge splitter; and
a first output gate through which the charge packet under a first one of said second plurality of gates is output wherein the charge packet under a second one of said second plurality of gates is output through said barrier gate.

22. The device of claim 21 wherein in response to the charge packet under said second one of said second plurality of gates being output via said barrier gate, the charge packet re-appears under one of said first plurality of gates.

23. The device of claim 22 wherein during a next fill phase of said fill-and-spill charge generator, the charge packet merges with an incoming charge from said diffusion and is discarded during a spill phase of said fill-and-spill charge generator.

24. The device of claim 23 wherein all charge movements necessary to S/H operation occur along the same axis.

25. An in-line sample-and-hold (S/H) device comprising:
a diffusion disposed to receive an input signal;
a first barrier gate coupled to said diffusion;
a first storage gate coupled to said first barrier gate;
a second barrier gate coupled to said first storage gate;
a second storage gate coupled to said second barrier gate, said second storage gate controllable by a first voltage;
a third barrier gate coupled to said second storage gate;
a third storage gate coupled to said third barrier gate, said third storage gate controllable by a second voltage, and wherein all charge flows through the S/H device occur along a same axis.

26. The device of claim 25 wherein said diffusion, said first barrier and first storage gate provide a spill and fill charge generator.

27. The device of claim 25 wherein said third barrier gate, said second storage gate and said third storage gate correspond to a differential voltage-to-charge S/H device.

28. The device of claim 25 wherein the clocking of said second barrier gate, said first storage gate and said first barrier gate is selected such that the charge under gate said second storage gate merges with fill and spill charge provided from the spill and fill charge generators.

29. The device of claim 25 further comprising a fourth barrier gate coupled to said third storage gate.

30. The device of claim 29 further comprising a fourth storage gate coupled to said fourth barrier gate, said fourth storage gate providing an output.

31. A differential sample-and-hold (S/H) device comprising:
a first in-line S/H device having first and second storage gates and a charge output path;
a second in-line S/H device having first and second storage gates and a charge output path;
means for providing a first voltage to the second storage gate of said first in-line S/H device and to the first storage gate of said second in-line S/H device; and
means for providing a second voltage to the first storage gate of said first-in-line S/H device and to the second storage gate of said second in-line S/H device.

32. The device of claim 31 wherein each S/H device comprises:
a fill-and-spill charge generator provided from a diffusion and a first plurality of gates, wherein a charge packet provided from said fill-and-spill charge generator is held under one of said first plurality of gates;
a charge splitter provided from a second plurality of gates;
a barrier gate which controls injection of the charge packet being held under one of said first plurality of gates under said second plurality of gates which provide said charge splitter; and
a first output gate through which the charge packet under a first one of said second plurality of gates is output wherein the charge packet under a second one of said second plurality of gates is output through said barrier gate.

33. A differential sample-and-hold (S/H) device comprising:
a first diffusion disposed to receive an input signal;
a first barrier gate coupled to said first diffusion;
a first storage gate coupled to said first barrier gate;
a second barrier gate coupled to said first storage gate;
a second storage gate coupled to said second barrier gate, said second storage gate controllable by a first voltage;
a third barrier gate coupled to said second storage gate;
a third storage gate coupled to said third barrier gate, said third storage gate controllable by a second voltage;
a second diffusion;
a fourth barrier gate coupled to said second diffusion;
a fourth storage gate coupled to said fourth barrier gate;
a fifth barrier gate coupled to said fourth storage gate;
a fifth storage gate coupled to said fifth barrier gate, said fifth storage gate controllable by said second voltage;
a sixth barrier gate coupled to said fifth storage gate;
a sixth storage gate coupled to said sixth barrier gate, said sixth storage gate controllable by said first voltage, and wherein all charge flows through said device occur along a same axis.

34. The device of claim 33 further comprising a seventh barrier gate coupled to said third storage gate.

35. The device of claim 34 further comprising a seventh storage gate coupled to said seventh barrier gate, said seventh storage gate providing a first output.

36. The device of claim 35 further comprising an eighth barrier gate coupled to said sixth storage gate.

37. The device of claim 36 further comprising an eighth storage gate coupled to said eighth barrier gate, said eighth storage gate providing a second output.

38. The device of claim 37 said first output and said second output are provided at a predetermined spacing interval.

39. A multiple-unit sample-and-hold (S/H) device comprising:
a first plurality of S/H unit cores, each of said plurality of S/H unit cores having first and second voltage input terminals and a charge output with first ones of the first and second voltage input terminals adapted to receive a first voltage and second ones of the first and second voltage input terminals adapted to receive a second voltage and with said charge outputs being combined to form a first combined charge output.

40. The device of claim 39 further comprising a second plurality of S/H unit cores each of said plurality of S/H unit cores having first and second voltage input terminals and a charge output with first ones of the first and second voltage input terminals adapted to receive said second voltage and second ones of the first and second voltage input terminals adapted to receive said first voltage and with said charge outputs being combined to form a second combined charge output.

41. The device of claim 39 wherein each of said plurality of S/H unit comprises:
a charge source having a charge output path; and
a S/H device having a charge input path coupled to the charge output path of said charge source.
